(19) United States
(12) Patent Application Publication
(10) Pub. No.: US 2004/0025582 A1
(43) Pub. Date: Feb. 12, 2004

(54) Method and apparatus for monitoring tire pressure with a color indicator

(75) Inventors: Fred J. Wiseman JR., Fullerton, CA (US); Laurence D. Miller, Yorba Linda, CA (US); Ronald D. Cook, Riverside, CA (US)

Correspondence Address: Seth D Levy, Pillsbury Winthrop LLP, 725 s Figueroa Street #2800, Los Angeles, CA, 90017, US

(73) Assignee: Tire Guard U.S.A., Fullerton, CA (US)

(21) Appl. No.: 10/215,179

(22) Filed: Aug. 8, 2002

(51) Int. Cl. B60C 23/02

(52) U.S. Cl. 73/146.8

(57) ABSTRACT

Disclosed herein is a method and apparatus for monitoring the air pressure of a tire. Various colors are displayed by the apparatus to denote an inflation level of the tire, and the apparatus may remain coupled to the air nozzle of a tire indefinitely. The apparatus may include a diaphragm that deforms in response to an air pressure differential on opposing sides thereof. Deformation of the diaphragm may alter the position of a color indicating cup, such that a color is displayed through an observation window, informing a user as to the inflation state of the tire.

### FIELD OF THE INVENTION

The present invention relates to the monitoring of air pressure in tires. More particularly, the invention relates to a method and apparatus for monitoring air pressure in tires utilizing colors to indicate a level of tire pressure.

### BACKGROUND OF THE INVENTION

Below optimum air pressure in the tires of automobiles, motorcycles and trucks is frequently associated with poor gas mileage, an increased risk of traffic accidents and greater wear on the tires themselves. Similarly, low tire pressure on other, non-motorized vehicles, such as bicycles and trailers, can have similar ramifications; increased risk of losing control of the vehicle and more rapid deterioration of the tires. It is therefore generally advantageous to maintain at least near optimum air pressure in the tires of a vehicle or other transportation apparatus.

Monitoring tire pressure can be an inconvenient task, and individuals oftentimes forsake safety and fuel economy for time savings. Manual pressure gauges may require one to remove a cap from an air nozzle, couple the gauge to the nozzle, observe an indication of tire pressure from the gauge, remove the gauge and reattach the cap to the nozzle. This arduous task must then be repeated for every tire on the vehicle; especially burdensome on a vehicle with many tires, such as large trucks that may have eighteen or more tires.

### SUMMARY OF THE INVENTION

It is therefore an object of an embodiment of the present invention to provide an apparatus for monitoring the air pressure of a tire that obviates, for practical purposes, the above-mentioned limitations. The apparatus of the present invention allows a user to monitor the air pressure of a tire, without the need to proceed through the series of steps enumerated above (i.e., removal of a cap, coupling of a device to an air nozzle, observation of a tire pressure reading, removal of the device, and subsequent reattachment of the cap). The apparatus may instead be coupled to the air nozzle of a tire, and may remain coupled to the nozzle for an indefinite period of time.

The apparatus may include a diaphragm that deforms in response to an air pressure differential on opposing sides thereof. Deformation of the diaphragm may alter the position of a color indicating cup, such that a color is displayed through an observation window, informing a user as to the inflation state of the tire. In particular embodiments, the apparatus may display a first color when the tire pressure is near optimum, and a second color when the tire pressure is sufficiently low that it should be filled with air. In alternate embodiments, the apparatus may display yet a third color when the tire pressure is below optimum yet still in an acceptable range. Combinations of the various colors may be simultaneously displayed when the air pressure of a tire is between the ranges defined thereby. A method of monitoring the air pressure of a tire utilizing the apparatus is further provided.

### BRIEF DESCRIPTION OF THE DRAWINGS

FIG. 1 depicts an exploded view of a tire pressure monitoring apparatus in accordance with an embodiment of the present invention.

FIG. 2 depicts a cross-sectional view of a tire pressure monitoring apparatus in accordance with an embodiment of the present invention. The device is depicted in the state indicating that tire pressure is insufficient.

FIG. 3 depicts a cross-sectional view of a tire pressure monitoring apparatus in accordance with an embodiment of the present invention. The device is depicted in the state indicating that tire pressure is within an acceptable range, although not optimum.

FIG. 4 depicts a cross-sectional view of a tire pressure monitoring apparatus in accordance with an embodiment of the present invention. The device is depicted in the state indicating that tire pressure is at least near optimum.

### DETAILED DESCRIPTION OF THE INVENTION

Embodiments of the present invention describe a tire pressure monitoring apparatus that indicates an inflation level of a tire with colors, and a method of monitoring the air pressure of a tire utilizing the same. The apparatus may be coupled to an air nozzle of a tire, and may remain coupled to the air nozzle indefinitely; thereby rendering the continued observation of tire pressure more convenient when compared with conventional devices, such as a traditional tire pressure gauge. Furthermore, the apparatus may be constructed of fewer parts than other tire pressure monitoring devices, potentially rendering the apparatus of the present invention more cost-effective to produce, more convenient to assemble and less likely to fail owing to human error in manufacturing.

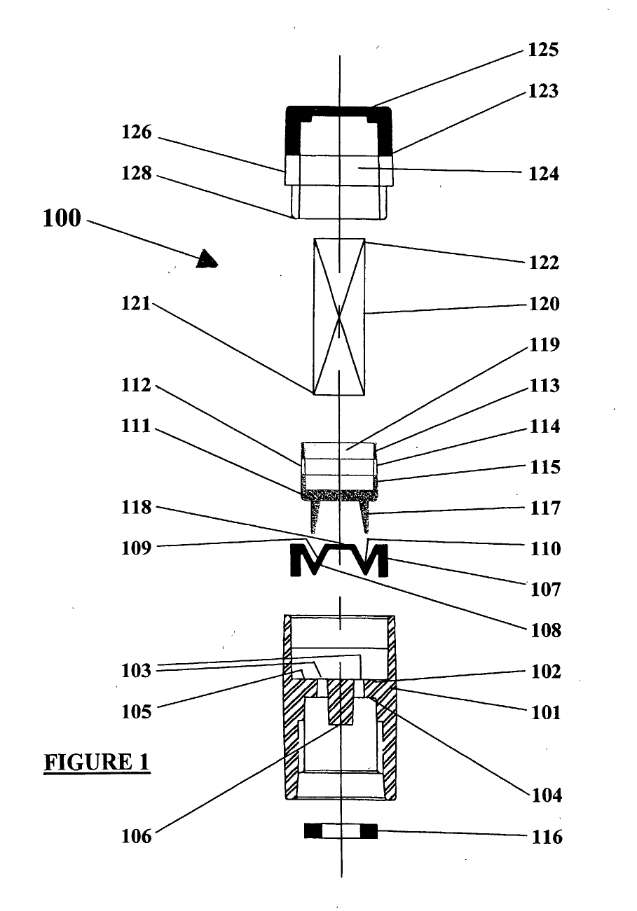

As depicted in FIG. 1, a tire pressure monitoring apparatus 100 may include a housing 101 that may be configured to attach to the exterior threading of an air nozzle of a tire (not shown). The housing 101 may be generally cylindrical in shape, although other geometric configurations may be utilized, for example, when desirable for ease of manufacturing. The housing 101 may include a partition 102 at or near the longitudinal center thereof, and may further include at least one air hole 103 traversing the partition 102 to provide air flow communication between opposing sides of the partition 102 (i.e., the nozzle side 104 and the diaphragm side 105). In a preferred embodiment, as depicted in FIG. 1, there may be two air holes 103.

The housing 101 may further include a valve stem 106 protruding from the center of the partition 102 in the direction of the air nozzle (not shown). The valve stem 106 may contact a central member of a conventional air nozzle thereby causing the air nozzle to open and provide gaseous communication between the interior of the tire (not shown) and the interior of the tire pressure monitoring apparatus 100. Further gaseous communication may be provided by the at least one air hole 103 disposed in the partition 102 of the housing 101. Moreover, in a preferred embodiment, an O-ring 116 may be included between the nozzle side 104 of the partition 102 and the air nozzle (not shown) to provide a substantially airtight seal between the tire pressure monitoring apparatus 100 and the air nozzle (not shown) when coupled to one another.

A diaphragm 107 may further be included in the tire pressure monitoring apparatus 100 of the present invention (FIG. 1). The diaphragm 107 may be constructed of any suitable, resilient material that has sufficient elastomeric properties such that the diaphragm 107 may deform owing to a predetermined air pressure differential on opposing sides thereof (i.e., a partition side 108 and a color indicator side 109), and may further return to its original configuration upon reduction of the air pressure differential to a predetermined level. The diaphragm 107 may be disposed on the diaphragm side 105 of the partition 102, and may be pressure-fit against the interior wall of the housing 101. In preferred embodiments, gaseous communication is not provided between the partition side 108 and the color indicator side 109 of the diaphragm 107. In the absence of such gaseous communication, an air pressure differential is created across the diaphragm 107; thereby deforming the diaphragm 107 to indicate the internal air pressure of the tire.

The diaphragm 107 may further include a depression 110 that allows the diaphragm 107 to deform when the air pressure differential on opposing sides 108, 109 thereof reaches a predetermined threshold level; deforming further as the air pressure differential increases, up to a maximum deformation. The material utilized to construct the diaphragm 107 may be selected to equate with differing threshold levels (i.e., to configure the tire pressure monitoring apparatus 100 for use with different types of tires, each having different air pressure characteristics and requirements). As such, the tire pressure monitoring apparatus 100 of the present invention may be configured for use with a range of tires, such as bicycle tires, automobile tires, truck tires and other types of tires that will be apparent to one of skill in the art.

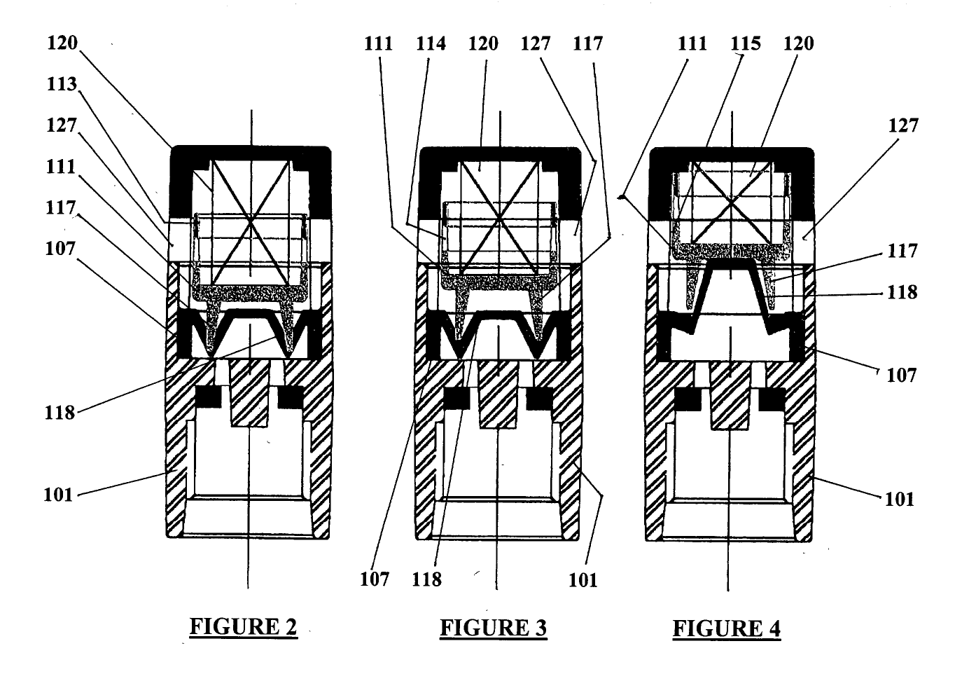

In those embodiments of the present invention wherein the housing 101 is substantially cylindrical, the diaphragm 107 may similarly be roughly cylindrical in shape, and the depression 110 disposed therein may be roughly circular. The depression 110 may further define a center portion 118 of the diaphragm 107; the center portion 118 being that component of the diaphragm 107 that deforms upon application of an air pressure differential thereto. The center portion 118 of the diaphragm 107 is at or near a maximally deformed state when the tire pressure is at or near an optimum inflation level, respectively (FIG. 4); an intermediate deformation state when the tire pressure is within an acceptable range, although not near optimum (FIG. 3); and a resting state when the tire pressure is insufficient (FIG. 2).

The tire pressure monitoring apparatus 100 of the present invention may further include a color indicating cup 111 (FIG. 1). The colors that denote particular inflation levels of a tire may appear on the exterior wall 112 of the color indicating cup 111. In a preferred embodiment of the present invention, there are three such colors depicted in bands around the exterior wall 112 of the color indicating cup 111: a first color band 115 (e.g., green), a second color band 113 (e.g., red) and a third color band 114 (e.g., yellow). The first color band 115 may indicate that the tire pressure is at least near optimum; the second color band 113 may indicate that the tire pressure is insufficient; and the third color band 114 may indicate that the tire pressure is within an acceptable range, although not near optimum. Therefore, the deformation state (i.e., including the resting state, when the second color band 113 is visible) of the diaphragm 107 may cause the corresponding color band to become visible to a user.

The color indicating cup 111 may further include a diaphragm receiving member 117. The diaphragm receiving member 117 may be roughly cylindrical or conical in shape, depending upon the configuration of the diaphragm 107 and the center portion 118 thereof. The diaphragm receiving member 117 may mate with the depression 110 in the diaphragm 107, and may further be configured to receive the center portion 118 of the diaphragm 107 when the diaphragm 107 deforms owing to an air pressure differential on opposing sides 108, 109 thereof (FIGS. 3 and 4), and/or when the diaphragm 107 is in its resting state (FIG. 2).

The color indicating cup 111 may further include an interior cavity 119, configured to receive the color indicating cup end 121 of a spring 120. The spring 120 may be included to provide mechanical resistance against the color indicating cup 111, such that the color indicating cup 111 remains mated to the diaphragm 107. In various embodiments of the present invention, the mechanical resistance provided by the spring 120 may aid in maintaining a proper mating between the color indicating cup 111 and the diaphragm 107, and may additionally aid in forcing the diaphragm 107 from a deformed state (FIGS. 3 and 4) to a resting state (FIG. 2). However, in preferred embodiments of the present invention, the mechanical resistance provided by the spring 120 is only sufficient for maintaining a proper mating between the color indicating cup 111 and the diaphragm 107, and in such embodiments does not provide the requisite force to aid in transforming the diaphragm 107 back to a resting state.

As also depicted in FIG. 1, the tire pressure monitoring apparatus 100 may include a cover 123 that further includes an interior chamber 124 to operably receive a cover end 122 of the spring 120. The cover 123 may be geometrically configured to correspond to the shape of the housing 101 (i.e., it may be roughly cylindrical in shape in those embodiments wherein the housing 101 is roughly cylindrical in shape). In a preferred embodiment of the present invention, the cover 123 may also include both an opaque portion 125 and a transparent portion 126. The opaque portion 125 of the cover 123 may conceal at least a portion of the interior chamber 124. The transparent portion 126, on the other hand, preferably circumscribes the cover 123 to provide an observation window 127 (FIGS. 2, 3 and 4) through which one can view at least one color indicating the present inflation level of the tire to which the tire pressure monitoring device 100 is attached.

One or more colors may be displayed at a particular time through the observation window 127. Preferably, only one color is displayed when the air pressure of the tire falls within a range defined by the corresponding color band 113, 114 or 115. However, since the inflation level may be at or near a level that is between two of the ranges that the color bands 113, 114, 115 denote, portions of multiple color bands may be simultaneously visible through the observation window 127. For example, the color band indicating an insufficient inflation level 113 as well as the color band indicating an inflation level that is within an acceptable range, although not near optimum 114 may be simultaneously displayed through the observation window 127. The display of multiple colors through the observation window 127 may still provide a user with an indication of the air pressure of a tire; the pressure is simply between two of the ranges defined by the color bands 113, 114 or 115.

The cover 123 may further include a base 128 that contacts the diaphragm 107 when the cover 123 and housing 101 are assembled together. In this embodiment, depicted in FIG. 1, the cover 123 thereby aids in maintaining the pressure-fit between the diaphragm 107 and the housing 101, and secures the diaphragm 107 in place. This may aid in preventing the leakage of air from a tire through the tire pressure monitoring device 100, while also providing mechanical support for the diaphragm 107.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A tire pressure monitoring apparatus, comprising:
a housing;
a diaphragm configured within said housing to deform in response to an air pressure differential;
a cover coupled to said housing to retain said diaphragm within said housing, said cover further including a transparent window; and
a color indicating cup disposed within said housing between said diaphragm and said cover, said color indicating cup being visible through said transparent window and further including:
a first color band to indicate that a tire pressure is at least near optimum; and
a second color band to indicate that a tire pressure is insufficient,
wherein a deformation state of said diaphragm causes said first color band, said second color band, or a portion of each of two color bands to become visible through said transparent window.

2. The tire pressure monitoring apparatus of claim 1, wherein said housing further includes a partition including at least one hole disposed therethrough.

3. The tire pressure monitoring apparatus of claim 2, wherein said partition includes two holes.

4. The tire pressure monitoring apparatus of claim 2, wherein said partition includes a valve stem adapted to contact a central member of an air nozzle.

5. The tire pressure monitoring apparatus of claim 1, wherein said cover further includes an opaque portion.

6. The tire pressure monitoring apparatus of claim 1, wherein said color indicating cup includes a third color band to indicate that a tire pressure is within an acceptable range, although not near optimum, said third color band being disposed between said first color band and said second color band.

7. The tire pressure monitoring apparatus of claim 1, further including a spring to maintain contact between said color indicating cup and said cover, said spring being disposed between said color indicating cup and said cover.

8. The tire pressure monitoring apparatus of claim 1, further including an O-ring to provide a substantially airtight seal between said housing and an air nozzle to which said housing is adapted to couple.

9. The tire pressure monitoring apparatus of claim 1, wherein said diaphragm includes a center portion to deform in response to an air pressure differential.

10. The tire pressure monitoring apparatus of claim 1, wherein said housing, said cover and said diaphragm are cylindrical.

11. A method for monitoring the air pressure of a tire, comprising:
observing a color band through a transparent window of an apparatus comprising:
a housing;
a diaphragm configured within said housing to deform in response to an air pressure differential;
a cover coupled to said housing to retain said diaphragm within said housing, said cover further including a transparent window; and
a color indicating cup disposed within said housing between said diaphragm and said cover, said color indicating cup being visible through said transparent window and further including:
a first color band to indicate that a tire pressure is at least near optimum; and
a second color band to indicate that a tire pressure is insufficient,
wherein a deformation state of said diaphragm causes said first color band, said second color band, or a portion of each of two color bands to become visible through said transparent window.

12. The method of claim 11, wherein said housing further includes a partition including at least one hole disposed therethrough.

13. The method of claim 12, wherein said partition includes two holes.

14. The method of claim 12, wherein said partition includes a valve stem adapted to contact a central member of an air nozzle.

15. The method of claim 11, wherein said cover further includes an opaque portion.

16. The method of claim 11, wherein said color indicating cup includes a third color band to indicate that a tire pressure is within an acceptable range, although not near optimum, said third color band being disposed between said first color band and said second color band.

17. The method of claim 11, wherein said apparatus further includes a spring to maintain contact between said color indicating cup and said cover, said spring being disposed between said color indicating cup and said cover.

18. The method of claim 11, wherein said apparatus further includes an O-ring to provide a substantially airtight seal between said housing and an air nozzle to which said housing is adapted to couple.

19. The method of claim 11, wherein said diaphragm includes a center portion to deform in response to an air pressure differential.

20. The method of claim 11, wherein said housing, said cover and said diaphragm are cylindrical.
